(19) United States
(12) Patent Application Publication
(10) Pub. No.: US 2017/0061776 A1
(43) Pub. Date: Mar. 2, 2017

(54) PROGNOSTICATING PANIC SITUATIONS AND PRE-SET PANIC NOTIFICATION IN A SECURITY SYSTEM

(71) Applicant: Honeywell International Inc., Morristown, NJ (US)

(72) Inventors: Nikhil Scaria, Kannur (IN); Galib Gaurav, Saharsa (IN); Chaithra Mandanna.K, Bangalore (IN); Sunil Parisi, Bangalore (IN); Divyashree Krishnamurthy, Bangalore (IN)

(21) Appl. No.: 14/834,558

(22) Filed: Aug. 25, 2015

(51) Int. Cl. G08B 25/00

(52) U.S. Cl. CPC G08B 25/001; G08B 25/008

(57) ABSTRACT

A system including a security system that protects a secured geographic area, a delayed alarm process executing on a processor of the security system, the delayed alarm process is activated by an authorized person through a user input of the security system, a timer of the delayed alarm process that delays sending an alarm message to a predetermined destination for a predetermined time period first following activation of the delayed alarm process by the person through the user input and a cancel feature of the delayed alarm process that disables the delayed alarm process upon receipt of an instruction from the authorized user wherein upon expiration of the predetermined time period without receipt of a reset, the delayed alarm process sends the alarm message to the predetermined destination.

### FIELD

This application relates to security systems and more particular to methods of protecting users of security systems.

### BACKGROUND

Systems are known to protect people and assets within secured areas. Such systems are typically based upon the use of one more wireless sensors that detect threats within the secured area.

Threats to people and assets may originate from any of number of different sources. For example, a fire may kill or injure occupants who have become trapped by a fire in a home. Similarly, carbon monoxide from a fire may kill people in their sleep.

Alternatively, an unauthorized intruder, such as a burglar, may present a threat to assets within the area. Intruders have also been known to injure or kill people living within the area.

In the case of intruders, sensors may be placed in different areas based upon the respective uses of those areas. For example, if people are present during some portions of a normal day and not at other times, then sensors may be placed along a periphery of the space to provide protection while the space is occupied while additional sensors may be placed within an interior of the space and used when the space is not occupied.

In most cases, threat detectors are connected to a local control panel. In the event of a threat detected via one of the sensors, the control panel may sound a local audible alarm. The control panel may also send a signal to a central monitoring station.

While conventional security systems work well, it is sometimes difficult to protect occupants when outside parties must be given entry into the secured area. Accordingly, a need exists for better methods and apparatus for protecting people within secured areas.

### BRIEF DESCRIPTION OF THE DRAWINGS

FIG. 1 illustrates a block diagram of a security system in accordance herewith; and

FIG. 2 illustrates a sequence of steps of use of the system of FIG. 1.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

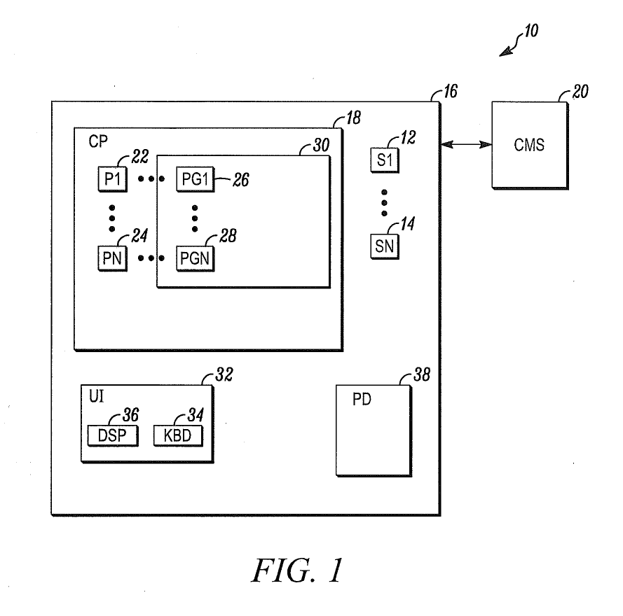

FIG. 1 depicts a security system 10 shown generally in accordance with an illustrated embodiment. Included within the system are a number of threat detectors 12, 14 that detect threats within a secured geographic area 16. The threat detectors may be embodied under any of a number of different formats. For example, at least some of the sensors may be switches placed on the doors and/or windows surrounding the secured area in order to detect intruders. Other sensors may be embodied as passive infrared (PIR) sensors or video cameras with motion detection capability placed within an interior of the secured area in order to detect intruders who have been able to circumvent the sensors placed along the periphery.

Still other of the sensors may detect environmental threats. For example, some of the other detectors may be fire or toxic gas detectors.

The threat detectors may be monitored by a control panel 18. The control panel may be located within the secured area as shown in FIG. 1 or located remotely. Upon detection of activation of one of the threat detectors, the control panel sends an alarm message to a central monitoring station 20. The central monitoring station may respond by summoning the appropriate help (e.g., fire department, police, etc.).

The system may be controlled via a user interface 32. For example, an authorized user may arm or disarm the system by entering a personal identifier (PIN) through a keyboard 34 followed by activation of a function key. Status information (e.g., armed, disarmed, etc.) may be shown on a display 36.

Under one illustrated embodiment, the system may also include a wireless portable device (e.g., a smartphone, iPad, etc.) 38 carried by an authorized user. The portable device also includes a keyboard and a display showing system status information.

Included within the control panel, the user interface and portable device may be circuitry that accomplishes the functionality described below. For example, the control panel, user interface and portable device may each include on or more processor apparatus (processors) 22, 24, each operating under control of one or more computer programs 26, 28 loaded from a non-transitory computer readable medium (memory) 30. As used herein, reference to a step performed by a computer program is also reference to the processor executing that step of the program.

In this regard, an alarm processor may monitor a status of each of the sensors. Upon detecting activation of one of the sensors, the processor may compose an alarm message to be sent to the central monitoring station. The alarm message may include an identifier of the system (e.g., an address, account number, etc.), an identifier of the sensor, an indicator of the type of sensor (e.g., fire, gas, intruder, etc.) and a time.

Similarly, a status processor may establish a system status by monitoring the user interface. Upon detecting entry of a predetermined PIN and arm key, the system enters an armed status. Similarly, upon detecting entry of a predetermined PIN and disarm key, the system enters a disarmed status.

From time to time, authorized users of the secured area may need to allow entry by unknown persons into the secured area. This may occur during delivery of furniture or other heavy appliances. Alternatively, a plugged drain may require admittance of a plumber. While such admittances normally do not represent a risk to the user, there have also been incidences where criminals have used the promise of delivery or service to gain entrance to a home for criminal activities. However, once inside a home, the criminal may seize upon the opportunity to attack or kill a homeowner or steal the homeowner's possessions.

In order to address this problem, the security system uses a special delayed alarm process (system) in order to allow entry by an unknown third party into the secured area while still providing at least some protection to an authorized user. The delayed alarm process may be initiated from either the armed or disarmed state by activating a predefined control key or pushbutton on the user interface. In the case of a home, the homeowner may activate the key before unlocking and opening the door for an unknown third party.

In effect, activating the delayed alarm pushbutton sets an alarm that will be reported to a predefined communication system destination after a predetermined time delay unless canceled or reset. The predetermined time delay may involve some appropriate delay (e.g., 5 minutes) that allows the homeowner enough time to open the door and determine the purpose of the visit by the third party. If the homeowner is comfortable that the visit is legitimate, then the homeowner may cancel the alarm. The homeowner may do this by activating a cancel button on the user interface thereby terminating the delayed alarm process.

If the homeowner is still unsure as to his/her safety, then the homeowner may activate a reset button. Activating the reset button does not cancel the alarm, but merely resets a timer inside the delayed alarm process that, in effect, doubles the time period during which the homeowner has to determine the legitimacy of the visit.

If the timer operating from within the delayed alarm process expires, then an alarm message is sent to the predetermined destination. The predetermined destination may be the central monitoring station and/or it may be a geographic neighbor of the authorized user. The neighbor (being close by) may receive the alarm and decide to investigate thereby ensuring the safety of the authorized user. In contrast, the central monitoring station may place a call to the authorized user to inquire as to the user's safety or simply summon the police.

In general, the delayed alarm process may be one or more software programs executing on a corresponding processor(s) of the security system. The activation, reset and cancel control buttons are pushbuttons or software keys displayed on the control panel of the security system.

Under one illustrated embodiment, the activation, reset and cancel pushbuttons of the delayed alarm process are also displayed on a portable device carried by the user. In this situation, a communication processor of the portable device forms a communication connection with the delayed alarm processor of the security system to transfer at least some of the control functionality of the delayed alarm process to the portable device. In this regard, a monitoring processor displays a warning to the authorized user when the predetermined time period is about to expire. For example, if the time delay is 5 minutes, then after 4 minutes and 40 seconds, the monitoring processor presents a warning on the portable device warning the authorized user that in another 20 seconds, a silent alarm will be sent to the predetermined destination.

In addition to displaying the warning, the monitoring processor may also display cancel and reset keys (pushbuttons) on the display of the portable device. Upon receiving the warning, the user may activate the cancel button to cancel the delayed alarm process(or) or activate the reset button to delay sending of the silent alarm for another 5 minutes.

In general, the delayed alarm process is a significant improvement over conventional security systems. For example, there are times when a person (e.g., a homeowner) may need outside services, such as a plumber or home delivery of household goods. There have been reported cases reported where a plumber or delivery service person has attacked and looted the residence of a homeowner. For example, even a criminal can be mistaken or disguised as a plumber or delivery person and come to the person's home in a manner that does not raise suspicions. Since the homeowner is expecting some person to visit him/her, the criminal or disguised person can easily enter the home without suspicion. Once inside, the intruder may attack the homeowner after entering his/her home. In such cases, the homeowner is often not in a situation to raise or otherwise activate a panic alarm. The trend of such crimes is very high in South Asian countries, such as India.

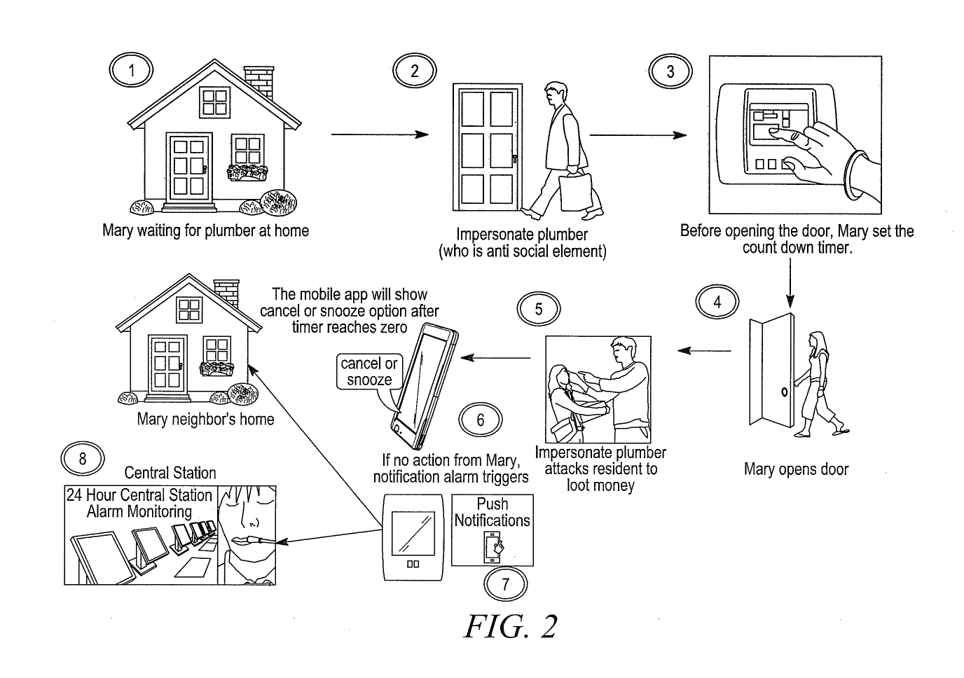

The delayed alarm system addresses the above described problem in a simple and robust manner. The use of the system may be exemplified by offering a simple series of steps for its use as shown in FIG. 2. For example, assume that Mary is alone at home each day after her husband John leaves for the office. Once day, John has a problem with his kitchen plumbing, so he calls a plumbing service for assistance. Tom the plumber (who has a criminal background) knocks on John's door, when John is not there. (People with criminal backgrounds are hired by such services in many countries, without much background investigation.)

Mary, who is alone at home, opens the door and allows Tom to come inside since she is expecting a plumber. By making use of this opportunity, Tom can attack Mary and loot the home. (Here is where the delay alarm system can be of use.) Before opening the door for Tom, Mary sets a countdown timer of the delayed alarm system for a specified interval of time into the security panel installed in her home. The system should allow the user to choose this period as required. It can ideally be 5 minutes, but any period can be chosen. The countdown timer starts ticking the moment Tom enters the home. In this case, there is also an app installed in Mary's cellphone, which is connected to the security panel (via WiFi or GPRS). The timer will send a prompt to Mary's phone, once the timer reaches zero, asking her to confirm that she is safe. There are two options in the app. The first option is to snooze (reset) the timer. (This will again start the countdown for the same period of time and repeat the same steps.) Mary will use this option, if Tom is still working in her kitchen. The second option is to cancel the timer. (This will cancel the timer or reset the app.) Mary will use this option, if Tom has left the home after finishing the job. To use both of these options, Mary has to enter the panel's user code.

If Mary doesn't press any of the buttons of the app, then it will be assumed that she is in trouble. The app will send an alert message to John as well as to a neighbor immediately (using a short message service (SMS)/recorded audio call, etc.). Upon receiving the notification, John/neighbor can come to Mary's aid. It should be noted that there is also an option of sending an alarm to the central monitoring station upon failing to receive a confirmation from Mary. If Mary doesn't cancel or snooze the timer within 30 seconds, there can be a continuous beeping sound generated by the panel. Even after another 30 seconds of beeping, if Mary doesn't cancel the alarm, a notification can be sent to the central monitoring service. Mary will be able to cancel the alarm from her mobile app at any time.

Anticipating panic situations and the ability to pre-set alarms/notifications in the panel are new features shown in FIGS. 1 and 2 and is not available in prior systems. The solution of FIGS. 1 and 2 is very much suited for many markets, where the situations cited above are frequently reported. Notifying neighbors is more effective in some countries, where first responder's (police, ambulance) response time is relatively high.

In general, the system includes a security system that protects a secured geographic area, a delayed alarm process executing on a processor of the security system, the delayed alarm process is activated by an authorized person through a user input of the security system, a timer of the delayed alarm process that delays sending an alarm message to a predetermined destination for a predetermined time period first following activation of the delayed alarm process by the person through the user input and a cancel feature of the delayed alarm process that disables the predetermined time period upon receiving instructions from the use wherein upon expiration of the predetermined time period without receipt of a reset, the delayed alarm process sends the alarm message to the predetermined destination.

Alternatively, the system includes a security system that protects a secured geographic area of a home or business, an alarm processor that protects an authorized human user of the security system within the secured area, the alarm processor is activated by the user through a user interface of the security system, a timer of the alarm process that waits a predetermined time period following activation by the user through the user input before issuing an alarm wherein the alarm is issued by sending an alarm message to a predetermined destination and a cancel feature of the alarm processor that disables the alarm processor upon receiving an acknowledgement from the authorized user before expiration of the predetermined time period.

Alternatively, the system includes a security system having one or more threat sensors that protects a secured geographic area of a home or business, an alarm processor of the security system that protects an authorized human user of the security system within the secured area, the alarm processor is activated by the user through a user interface of the security system, a timer of the alarm process that waits a predetermined time period following activation through the user input before issuing an alarm by sending an alarm message to a predetermined destination, a cancel feature of the alarm processor that cancels the alarm by disabling the alarm processor or resets the predetermined time period upon receiving instructions from the authorized user before expiration of the predetermined time period and a wireless portable device carried by the authorized user that provides instructions to cancel the alarm or reset the timer.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. An apparatus comprising:
a security system that protects a secured geographic area;
a delayed alarm process executing on a processor of the security system, the delayed alarm process is activated by an authorized person through a user input of the security system;
a timer of the delayed alarm process that delays sending an alarm message to a predetermined destination for a predetermined time period first following activation of the delayed alarm process by the person through the user input; and
a cancel feature of the delayed alarm process that disables the delayed alarm process upon receipt of a cancel instruction from the authorized user wherein upon expiration of the predetermined time period without receipt of a reset, the delayed alarm process sends the alarm message to the predetermined destination.

2. The apparatus as in claim 1 wherein the user input further comprising a portable wireless device carried by the authorized person.

3. The apparatus as in claim 1 further comprising a reminder feature of the delayed alarm process executing on a processor that sends a reminder that the predetermined time period is about to expire to the authorized person.

4. The apparatus as in claim 3 further comprising a portable wireless device of the authorized user that displays the reminder.

5. The apparatus as in claim 4 further comprising a wireless application executing on a processor of the portable device that couples the delayed alarm process with a user interface of the portable device.

6. The apparatus as in claim 5 further comprising a user input of the portable device that displays a reset button of the delayed alarm process wherein activation of the resets button of the portable device resets the predetermined time period of the delayed alarm process through the wireless application.

7. The apparatus as in claim 5 further comprising a user input of the portable device that displays a cancel button of the delayed alarm process wherein activation of the cancel button of the portable device cancels the delayed alarm process through the wireless application.

8. The apparatus as in claim 1 wherein the predetermined destination further comprises a system address of a neighbor of the authorized person.

9. The apparatus as in claim 1 wherein the predetermined destination further comprises a system address of a central monitoring station.

10. An apparatus comprising:
a security system that protects a secured geographic area of a home or business;
an alarm processor that protects an authorized human user of the security system within the secured area, the alarm processor is activated by the user through a user interface of the security system;
a timer of the alarm process that waits a predetermined time period following activation by the user through the user input before issuing an alarm wherein the alarm is issued by sending an alarm message to a predetermined destination; and
a cancel feature of the alarm processor that disables the alarm processor upon receiving a cancel instruction from the authorized user before expiration of the predetermined time period.

11. The apparatus as in claim 10 wherein the user input further comprising a portable wireless device carried by the authorized user.

12. The apparatus as in claim 11 further comprising a reminder processor of the security system that sends a reminder to the authorized user that the predetermined time period is about to expire.

13. The apparatus as in claim 12 further comprising a portable wireless device of the authorized user that displays the reminder.

14. The apparatus as in claim 13 further comprising a wireless application executing on a processor of the portable device that couples the alarm processor with a user interface of the portable device.

15. The apparatus as in claim 14 wherein the user interface of the portable device further comprises a reset button of the alarm processor displayed on the portable device wherein activation of the reset button of the portable device resets the predetermined time period of the alarm processor through the wireless application.

16. The apparatus as in claim 14 further comprising a user input of the portable device that displays a cancel button of the alarm processor wherein activation of the cancel button cancels the alarm through the wireless application.

17. The apparatus as in claim 10 wherein the predetermined destination further comprises a system address of a neighbor of the authorized person.

18. The apparatus as in claim 10 wherein the predetermined destination further comprises a system address of a central monitoring station.

19. An apparatus comprising:
a security system having one or more threat sensors that protects a secured geographic area of a home or business;
an alarm processor of the security system that protects an authorized human user of the security system within the secured area, the alarm processor is activated by the user through a user interface of the security system;
a timer of the alarm process that waits a predetermined time period following activation through the user input before issuing an alarm by sending an alarm message to a predetermined destination;
a cancel feature of the alarm processor that cancels the alarm or resets the predetermined time period upon receiving instructions from the authorized user before expiration of the predetermined time period; and
a wireless portable device carried by the authorized user that provides instructions to cancel the alarm or reset the timer.

20. The system as in claim 19 wherein the predetermined destination further comprises one of a neighbor of the authorized user or a central monitoring station.
